(19) United States
(12) Patent Application Publication
(10) Pub. No.: US 2025/0342623 A1
(43) Pub. Date: Nov. 6, 2025

(54) METHOD AND APPARATUS FOR PERFORMING PARAMETER ADAPTATION IN CT IMAGING SYSTEMS

(71) Applicant: CANON MEDICAL SYSTEMS CORPORATION, Tochigi (JP)

(72) Inventors: Chih-Chieh LIU, Vernon Hills, IL (US); Qiulin TANG, Vernon Hills, IL (US); Jian ZHOU, Vernon Hills, IL (US); Liang CAI, Vernon Hills, IL (US); Zhou YU, Vernon Hills, IL (US)

(73) Assignee: CANON MEDICAL SYSTEMS CORPORATION, Tochigi (JP)

(21) Appl. No.: 18/652,582

(22) Filed: May 1, 2024

(51) Int. Cl. G06T 11/00; G06T 7/00; G06T 7/20; G06T 7/62; H04N 5/14

(52) U.S. Cl. CPC G06T 11/005; G06T 7/0012; G06T 7/20; G06T 7/62; H04N 5/145; G06T 2207/10081; G06T 2207/20132; G06T 2207/30048

(57) ABSTRACT

An apparatus for performing parameter adaptation for motion compensation in a computed tomography (CT) imaging system is provided. The apparatus includes processing circuitry configured to receive projection data acquired from imaging an object using the CT imaging system, reconstruct, based on the received projection data, an image of the object, without performing motion compensation, identify a vessel in the reconstructed image, the vessel including a plurality of vessel slices, determine, based on features of the identified vessel, parameters to be used during motion estimation of the identified vessel, estimate a vessel motion field using the determined parameters, and reconstruct, based on the received projection data and the estimated vessel motion field, a motion-compensated image of the object.

### CROSS-REFERENCE TO RELATED APPLICATIONS

This application is related to U.S. patent application Ser. No. 18/516,450 (Attorney Docket No. 546525US) entitled “METHOD AND APPARATUS FOR PERFORMING MOTION COMPENSATION IN CARDIAC CT IMAGING SYSTEMS”, filed on Nov. 21, 2023, the content of which is incorporated herein by reference.

### BACKGROUND

### Field

This disclosure relates to X-ray computed tomography (CT) imaging systems.

### Description of the Related Art

Cardiac CT is one of the most challenging fields in medical imaging because the heart is constantly moving, with both regular and irregular motion patterns. Thus, advanced imaging techniques are required to capture clear cardiac images while the heart and the blood vessels are in motion.

Different compensation methods for restoring image quality have been used to mitigate the influence of artifacts induced by cardiac motion. Most of these methods have two major phases: (1) estimation of cardiac motion, and (2) incorporation of the estimated motion into the image reconstruction process to counter motion artifacts. The performance of these motion compensation methods is mainly determined by the accuracy of the motion estimation phase.

It is desirable to enhance current cardiac motion compensation approaches.

### SUMMARY

The present disclosure relates to an apparatus for performing parameter adaptation for motion compensation in a computed tomography (CT) imaging system. The apparatus includes processing circuitry configured to receive projection data acquired from imaging an object using the CT imaging system, reconstruct, based on the received projection data, an image of the object, without performing motion compensation, identify a vessel in the reconstructed image, the vessel including a plurality of vessel slices, determine, based on features of the identified vessel, parameters to be used during motion estimation of the identified vessel, estimate a vessel motion field using the determined parameters, and reconstruct, based on the received projection data and the estimated vessel motion field, a motion-compensated image of the object.

The disclosure additionally relates to a method for performing parameter adaptation for motion compensation in a computed tomography (CT) imaging system. The method includes receiving projection data acquired from imaging an object using the CT imaging system, reconstructing, based on the received projection data, an image of the object, without performing motion compensation, identifying a vessel in the reconstructed image, the vessel including a plurality of vessel slices, determining, based on features of the identified vessel, parameters to be used during motion estimation of the identified vessel, estimating a vessel motion field using the determined parameters, and reconstructing, based on the received projection data and the estimated vessel motion field, a motion-compensated image of the object.

The disclosure also relates to a non-transitory computer-readable medium storing instructions. The instructions, when executed by a processor, can cause the processor to perform the above method for performing parameter adaptation for motion compensation in a computed tomography (CT) imaging system.

Note that this summary section does not specify every embodiment and/or incrementally novel aspect of the present disclosure or claimed invention. Instead, the summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a block diagram of an exemplary apparatus 100 for performing motion estimation and compensation in a CT imaging system in accordance with embodiments of the disclosure;

FIG. 2 shows a block diagram of adaptive parameter tuning circuitry 130 in accordance with embodiments of the disclosure;

FIG. 3 shows a flow chart of an exemplary procedure 300 for performing parameter adaptation in accordance with embodiments of the disclosure;

FIG. 4 shows a block diagram of mask size adaptation circuitry 230 in accordance with embodiments of the disclosure;

FIG. 5 shows a vessel identified in a reconstructed cardiac CT image in accordance with embodiments of the disclosure;

FIG. 6A shows an exemplary vessel slice identified in a reconstructed CT image, in accordance with embodiments of the disclosure;

FIG. 6B shows an exemplary vessel region cropped using a default vessel mask, in accordance with embodiments of the disclosure;

FIG. 6C shows an exemplary vessel motion artifact obtained within the vessel region, in accordance with embodiments of the disclosure;

FIG. 6D shows exemplary vessel motion artifacts obtained through a thresholding process based on different CT value thresholds, in accordance with embodiments of the disclosure;

FIG. 6E shows an exemplary circular vessel mask in accordance with embodiments of the disclosure;

FIG. 7 shows a flow chart of an exemplary procedure 700 for performing mask size adaptation in accordance with embodiments of the disclosure;

FIG. 8 shows a block diagram of number-of-control-points adaptation circuitry 240 in accordance with embodiments of the disclosure;

FIG. 9 shows a flow chart of an exemplary procedure 900 for performing adaptation of the number of the control points in accordance with embodiments of the disclosure;

FIG. 10 shows a block diagram of positions-of-control-points adaptation circuitry 250 in accordance with embodiments of the disclosure;

FIG. 11A shows a graph depicting the distribution of calculated entropy values along an identified vessel in accordance with embodiments of the disclosure;

FIG. 11B shows exemplary positions of the control points assigned along the identified vessel in accordance with embodiments of the disclosure;

FIG. 12 shows a flow chart of an exemplary procedure 1200 for performing adaptation of the positions of the control points in accordance with embodiments of the disclosure; and

FIG. 13 shows a schematic block diagram of an exemplary CT imaging system that can incorporate the techniques disclosed herein.

### DETAILED DESCRIPTION

The following disclosure provides embodiments or examples for implementing different features of the provided subject matter. Specific examples of components and arrangements are described below to simplify the present disclosure. These are, of course, merely examples and are not intended to be limiting.

For example, the order of discussion of the different steps as described herein has been presented for the sake of clarity. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

Furthermore, as used herein, the words “a,” “an,” and the like generally carry a meaning of “one or more,” unless stated otherwise.

Typically, artifacts arising from vessel motion give rise to various vessel deformation patterns, including but not limited to crescent shapes, elongated tails, and horn-like distortions. In the field of cardiac CT imaging, coronary arteries are the major regions-of-interest for the diagnosis of cardiovascular diseases. The motion characteristics, including both magnitude and direction, can vary significantly along coronary arteries, thereby presenting challenges for motion estimation and compensation.

U.S. patent application Ser. No. 18/516,450 (Attorney Docket No. 546525US) relates to a method and apparatus that integrate motion estimation and motion compensation in cardiac CT imaging systems, instead of executing the two phases independently. In this approach, motion estimation and motion compensation are executed in an iterative manner, until a predefined termination criterion is met. During the iterations, a motion field, composed of motion vectors on a number of control points assigned along the target vessel, is continuously updated and optimized based on a cost function. By doing so, the accuracy of motion estimation can be enhanced during motion compensation, and the efficiency of motion compensation can be improved through the motion estimation process.

Using an entire reconstructed image in the above-mentioned optimization process can impose an excessively high computational burden. In order to reduce the computational load and speed up the procedure, it is advantageous to narrow the focus to specific vessel regions by using a vessel mask to crop them from the reconstructed image.

However, there is not a universally applicable set of parameters that can accommodate the wide-ranging conditions encountered in individual patients. These disparities include variations in vessel length, curvature, the presence of abnormalities, and the specifics of image acquisition protocols, for example.

Therefore, to achieve accurate motion estimation and compensation, it is desirable to adapt or tune those parameters in advance. The adaptation can include customization of the size of the vessel region masks around different sections of the target vessel, as well as the positions and the number of the control points used in the image non-rigid registration, etc.

Aspects of this disclosure are directed to a method and apparatus for adapting parameters involved in motion estimation and compensation within a CT imaging system. While the embodiments are described in the context of cardiac CT imaging, those skilled in the art can recognize that the approaches can be applied to the imaging of other vessel structures, without departing from the spirit and scope of the disclosure.

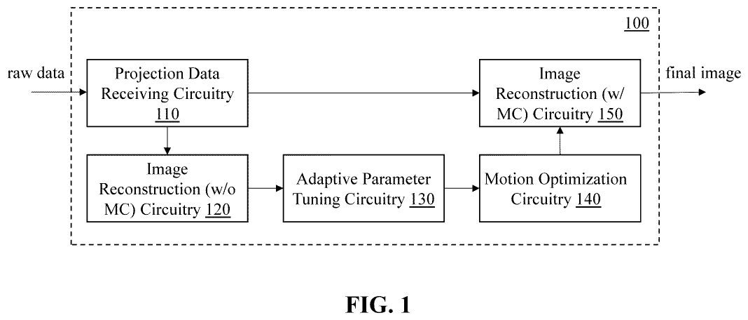

FIG. 1 shows a block diagram of an exemplary apparatus 100 for performing motion estimation and compensation in a CT imaging system in accordance with embodiments of the disclosure. The apparatus 100 includes projection data receiving circuitry 110, image reconstruction (without motion compensation) circuitry 120, adaptive parameter tuning circuitry 130, motion optimization circuitry 140, and image reconstruction (with motion compensation) circuitry 150. For the sake of clarity, the iterative optimization of the motion field described in U.S. patent application Ser. No. 18/516,450 (Attorney Docket No. 546525US) is illustrated in FIG. 1 as implemented by the motion optimization circuitry 140.

The projection data receiving circuitry receives raw projection data acquired from imaging an imaging object by the CT imaging system, and sends the data to the image reconstruction (without motion compensation) circuitry 120 and the image reconstruction (with motion compensation) circuitry 150.

The image reconstruction (without motion compensation) circuitry 120 reconstructs the projection data to generate an image of the imaging object, and sends the generated image to the adaptive parameter tuning circuitry 130. The image reconstruction process does not include any motion correction.

The adaptive parameter tuning circuitry 130 can tune adaptive parameters involved in the motion field optimization, and sends the tuned parameters to the motion optimization circuitry 140. For example, these adaptive parameters include the sizes of the vessel region masks, the number of the control points, and the specific positions of these control points.

Using the adapted parameters, the motion optimization circuitry 140 optimizes the vessel motion field and sends it to the image reconstruction (with motion compensation) circuitry 150.

Based on the optimized motion field, the image reconstruction (with motion compensation) circuitry 150 reconstructs a motion-compensated image of the imaging object, and outputs it as a final image.

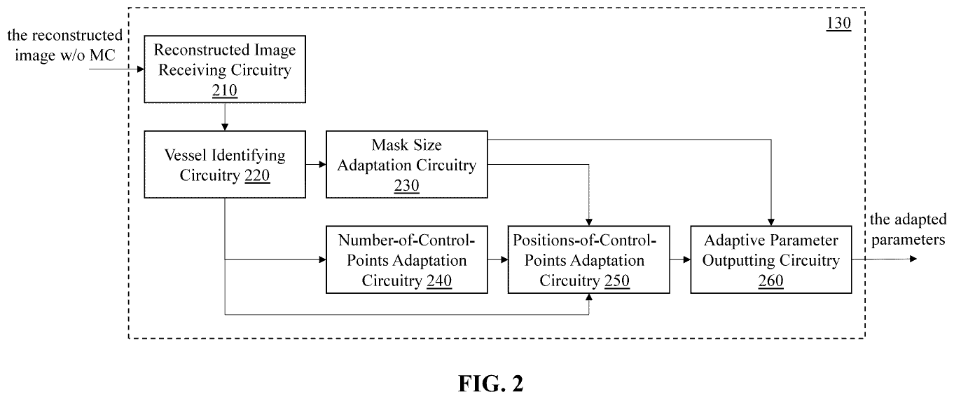

FIG. 2 shows a block diagram of the adaptive parameter tuning circuitry 130 in accordance with embodiments of the disclosure. The adaptive parameter tuning circuitry 130 includes reconstructed image receiving circuitry 210, vessel identifying circuitry 220, mask size adaptation circuitry 230, number-of-control-points adaptation circuitry 240, positions-of-control-points adaptation circuitry 250, and adaptive parameter outputting circuitry 260.

The reconstructed image receiving circuitry 210 receives the image of the imaging object from the image reconstruction (without motion compensation) circuitry 120, and sends it to the vessel identifying circuitry 220.

The vessel identifying circuitry 220 identifies a specific vessel within the received image, and sends it to the mask size adaptation circuitry 230, the number-of-control-points adaptation circuitry 240, and the positions-of-control-points adaptation circuitry 250. This vessel identification can be carried out using various methods, including neural-network-based or image-processing-based approaches, for example.

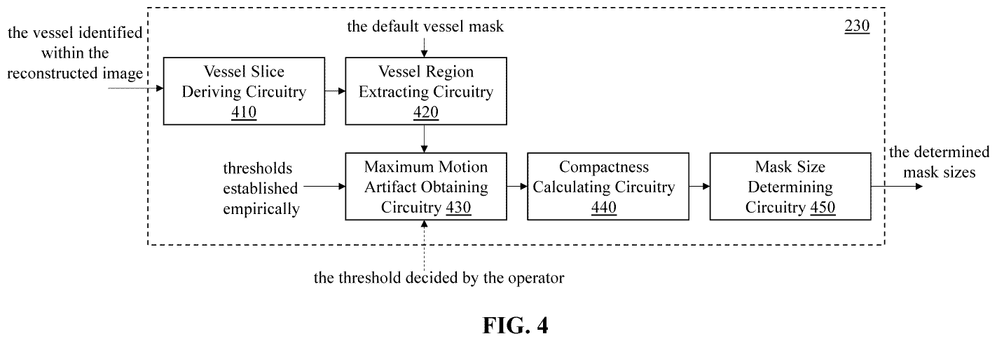

The mask size adaptation circuitry 230, the number-of-control-points adaptation circuitry 240, and the positions-of-control-points adaptation circuitry 250 determine the sizes of vessel region masks, and the number and the positions of the control points to be used during the subsequent motion estimation and compensation procedure. These determinations can be made by taking into account the unique characteristics of the imaging object, such as the length of the target vessel and the extent of motion artifacts, etc. Further details about the adaptation process will be described below with reference to FIGS. 4-12.

The adaptive parameter outputting circuitry 250 receives the adapted parameters and outputs them to the motion optimization circuitry 140.

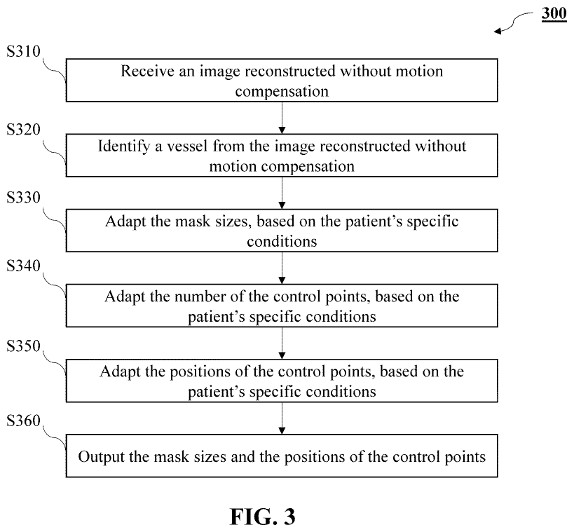

FIG. 3 shows a flow chart of an exemplary procedure 300 for performing parameter adaptation in accordance with embodiments of the disclosure. In step S310, an image of the imaging object is received, which can be reconstructed without motion compensation. In step S320, the target vessel is identified within the received CT image. Steps S330-S350 correspond to the adaptation of vessel mask sizes, the number of the control points, and the positions of the control points, respectively. Finally, in step S360, the adapted or determined mask sizes and the positions of the control points are output for utilization in the subsequent motion optimization phase.

FIG. 4 shows a block diagram of the mask size adaptation circuitry 230 in accordance with embodiments of the disclosure. The mask size adaptation circuitry 230 includes vessel slice deriving circuitry 410, vessel region extracting circuitry 420, maximum motion artifact obtaining circuitry 430, compactness calculating circuitry 440, and mask size determining circuitry 450.

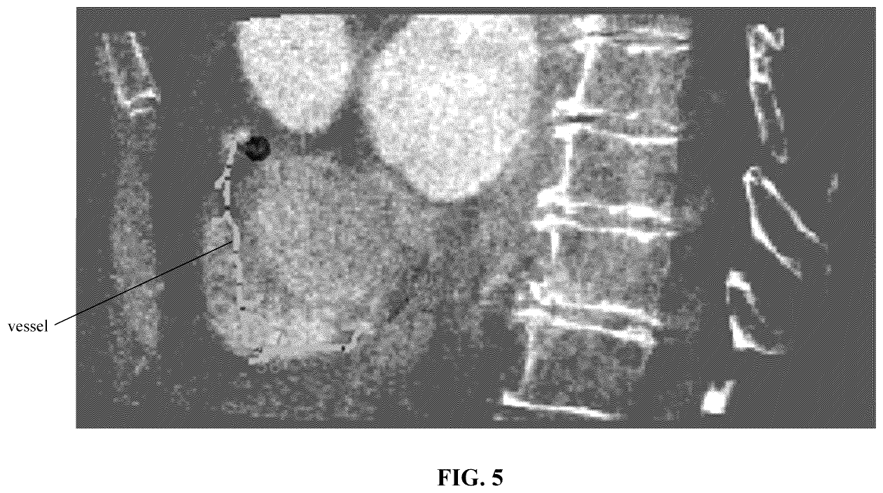

The vessel slice deriving circuitry 410 derives vessel slices included in the vessel identified within the reconstructed image, and sends them to the vessel region extracting circuitry 420. As an example, FIG. 5 illustrates a reconstructed CT image where the target vessel, composed of multiple vessel slices, can be discerned within the CT image.

The vessel region extracting circuitry 420 uses a uniform default vessel mask to extract or crop the corresponding vessel regions for the derived vessel slices, and sends them to the maximum motion artifact obtaining circuitry 430. This default vessel mask can maintain the same size across different vessel slices, and does not require specific adjustments for individual vessel slices.

The maximum motion artifact obtaining circuitry 430 obtains a maximum motion artifact within each of the vessel regions, and sends these obtained maximum motion artifacts to the compactness calculating circuitry 440.

Inherent variations in CT values can occur among different patients, varying magnitudes of motion, or during various data acquisition sessions. To ensure inclusion of all relevant motion artifacts for accurate motion correction, the maximum motion artifact obtaining circuitry 430 can perform a thresholding process on the vessel region, using a range of CT value thresholds, e.g., 20%, 30%, 40%, 50%, etc. Small and remote segments are removed during the thresholding process in order to ensure that all and only the vessel slice and its motion artifacts are considered when obtaining the maximum motion artifact. This final maximum motion artifact is then used in calculating the mask size for the vessel slice, as described below.

Alternatively, a desired threshold can also be manually selected by the operator of the CT imaging system. For instance, the operator can make this selection based on their visual assessment and judgment regarding whether a tail-like artifact should be encompassed or excluded from the maximum motion artifact.

Through the thresholding process, inadvertent omission of artifacts can be prevented during the subsequent motion estimation and compensation procedure, ensuring the accuracy of the correction process.

The compactness calculating circuitry 440 calculates a compactness measurement for each of the maximum motion artifacts obtained with respect to the extracted vessel regions. For example, the compactness measurement can be calculated using the following formula:

$$Compactness = \frac{{p}^{2}}{4 π A} ,$$

where P represents the perimeter of the maximum motion artifact, and A represents the area of the maximum motion artifact. In the context of this compactness measurement, a value of 1 means the highest level of compactness, which corresponds to a perfect circle, while higher values indicate reduced compactness, corresponding to shapes that deviate from a circular form.

Based on the compactness measurement calculated with respect to each of the vessel slices, the mask size determining circuitry 450 determines a mask size for the vessel slice, which is sent to the positions-of-control-points adaptation circuitry 240 and the adapted parameter outputting circuitry 250. This determination can be carried out through various methods, one example of which can use a look-up table. In this approach, a look-up table can be constructed by compiling a dataset that pairs compactness measurements with their corresponding mask sizes. Subsequently, the appropriate mask size can be determined by referencing the look-up table, using the compactness measurement as a key. Those skilled in the art can also appreciate that the determination can be alternatively achieved by using a trained neural network, for example.

Note that the compactness measurement provided here is merely an illustrative example. Various other morphological metrics, including but not limited to entropy, circularity, Euclidean distance, elongation, and convexity, can be used without departing from the spirit and scope of this disclosure.

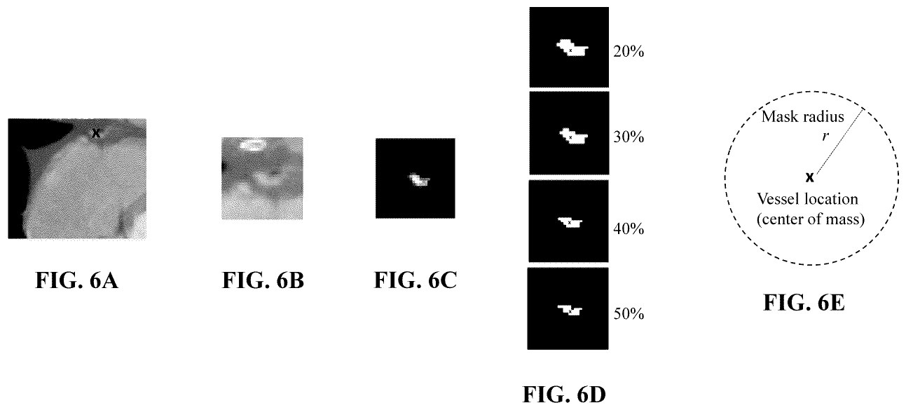

One exemplary vessel slice within a reconstructed cardiac CT image is illustrated in FIG. 6A. The location of this vessel slice can be represented by its center of mass. FIG. 6B shows an exemplary vessel region cropped from the reconstructed image using a default vessel mask. The size of the default vessel mask can be predefined sufficiently large, allowing it to cover not only the whole vessel slice, but also potential motion artifacts that may occur across diverse patient cases.

An exemplary vessel motion artifact obtained after removal of small features or objects around the vessel slice is shown in FIG. 6C. Through the thresholding process illustrated in FIG. 6D, the maximum vessel motion artifact can be identified and captured. As mentioned above, this process is performed to avoid missing any artifacts that should be corrected. FIG. 6E shows an exemplary vessel mask of a circular shape, with a radius r. The center of this circular mask can align with the vessel slice location (represented by the center of mass of the slice).

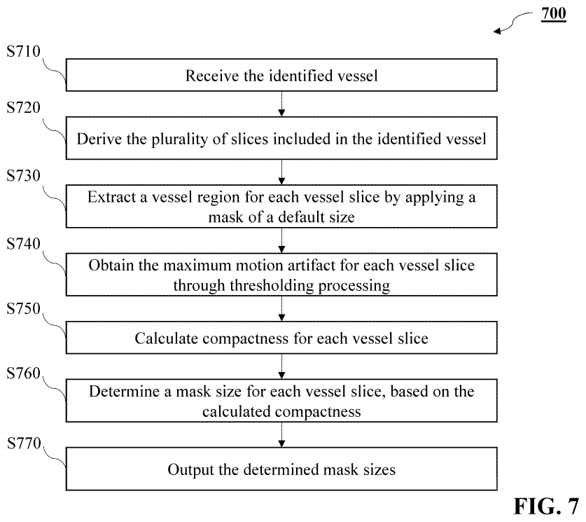

FIG. 7 shows a flow chart of an exemplary procedure 700 for performing mask size adaptation in accordance with embodiments of the disclosure. In step S710, the identified vessel is received, which includes a plurality of vessel slices. In step S720, the plurality of vessel slices included in the identified vessel are derived. In step S730, a vessel region is extracted for each vessel slice by applying a default vessel mask. In step S740, a maximum motion artifact is obtained with respect to each vessel slice, through a thresholding processing based on a set of predefined CT value thresholds. In step S750, a compactness measurement is calculated for each vessel slice. In Step S760, a mask size is determined for each vessel slice, based on the compactness calculated with respect to the slice. In step S770, the determined mask sizes are output.

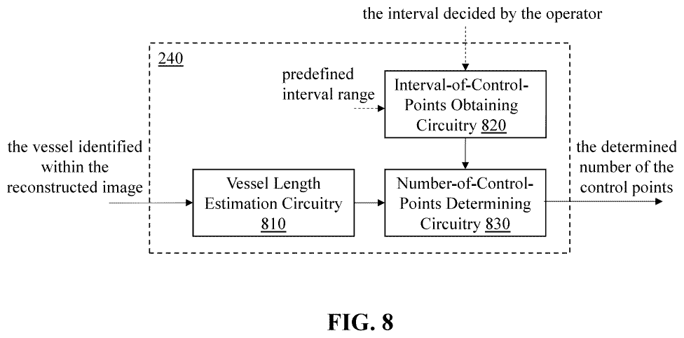

FIG. 8 shows a block diagram of number-of-control-points adaptation circuitry 240 in accordance with embodiments of the disclosure. The number-of-control-points adaptation circuitry 240 includes vessel length estimation circuitry 810, interval-of-control-points obtaining circuitry 820, and number-of-control-points determining circuitry 830.

The vessel length estimation circuitry 810 receives the vessel identified within the reconstructed image, estimates the length of the identified vessel, and sends it to the number-of-control-points determining circuitry 830. For example, the vessel length estimation circuitry 810 can track the vessel from its starting point to its ending point, accumulating the lengths of the multiple vessel slices to estimate the overall vessel length.

The interval-of-control-points obtaining circuitry 820 obtains the desired interval between adjacent control points, and sends it to the number-of-control-points determining circuitry 830. This interval can be determined through empirical methods, typically falling within a range of 15-20 mm. Alternatively, it can be manually set by the operator of the CT imaging system.

Based on the received interval between adjacent control points and the estimated vessel length, the number-of-control-points determining circuitry 840 determines the number of the control points to be used during the motion estimation and compensation process. For example, the number of the control points can be readily calculated as the vessel length divided by the interval between adjacent control points.

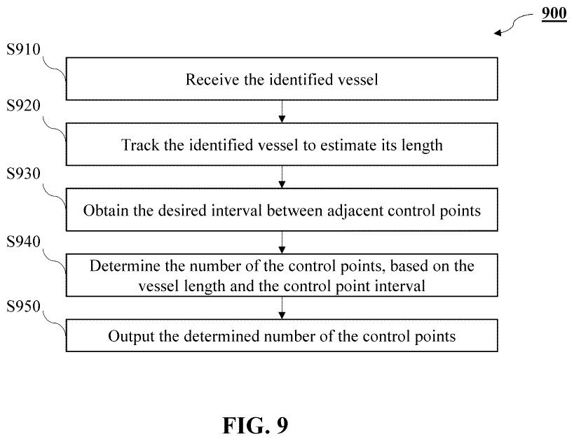

FIG. 9 shows a flow chart of an exemplary procedure 900 for performing adaptation of the number of the control points in accordance with embodiments of the disclosure. In step S910, the identified vessel is received. In step S920, the identified vessel is tracked to estimate its length. In step S930, the desired interval between adjacent control points is obtained. In step S940, the number of the control points is determined based on the vessel length and the control point interval. In step S950, the determined number of the control points is output.

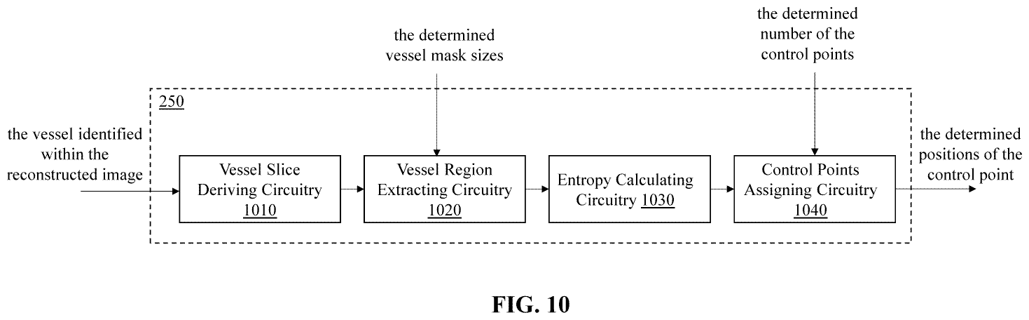

FIG. 10 shows a block diagram of positions-of-control-points adaptation circuitry 250 in accordance with embodiments of the disclosure. The positions-of-control-points adaptation circuitry 250 includes vessel slice deriving circuitry 1010, vessel region extracting circuitry 1020, entropy calculating circuitry 1030, and control point assigning circuitry 1040.

The vessel slice deriving circuitry 1010 derives the plurality of vessel slices included in the identified vessel, and sends them to the vessel region extracting circuitry 1020.

Using the vessel mask sizes determined by the mask size adaptation circuitry 230, the vessel region extracting circuitry 1020 extracts respective vessel regions with respect to the derived plurality of vessel slices. More specifically, the vessel region extracting circuitry 1020 extracts a corresponding vessel region around each of the vessel slices by applying a vessel mask of a size corresponding to that vessel slice.

The entropy calculating circuitry 1030 receives the extracted vessel regions with respect to the plurality of vessel slices. The entropy calculating circuitry 1030 calculates an entropy value for each of the extracted vessel regions. For example, the entropy calculating circuitry 1030 can identify a vessel motion artifact in each of the extracted vessel regions, and calculate an entropy value associated with the vessel motion artifact.

Those skilled in the art can appreciate that other forms of metric can be calculated to characterize or quantify the level of the vessel motion artifact, including but not limited to compactness, circular scores, etc.

The control point assigning circuitry 1040 receives the number of the control points determined by the number-of-control-points adaptation circuitry 240, and the entropy values from the entropy calculating circuitry 1030. The control point assigning circuitry 1040 utilizes the calculated entropy values to position the determined number of control points along the identified vessel.

For example, the control point assigning circuitry 1040 can determine control point positions based on the distribution of the entropy values along the identified vessel. Specifically, the control points can be assigned along the vessel, typically at or near peaks representing high motion level in the curve of the entropy values.

For instance, the control point assigning circuitry 1040 can determine control point positions by assigning more control points to sections of the identified vessel including a greater number of vessel slices with entropy values exceeding a predefined threshold, as compared with sections with fewer slices exceeding the predefined threshold.

For instance, control points may not be assigned to vessel slices with entropy values below a predefined threshold.

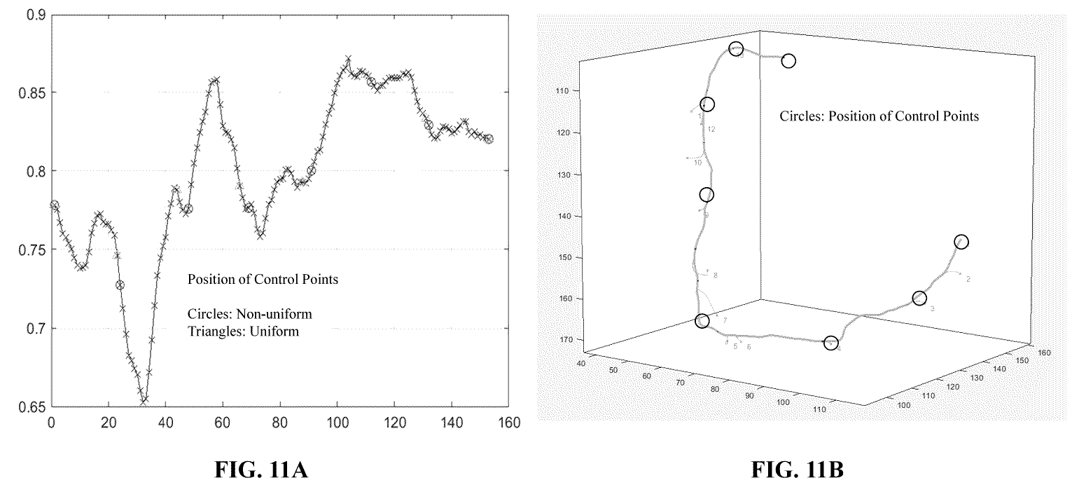

FIG. 11A shows a graph depicting the distribution of the calculated entropy values along the identified vessel in accordance with embodiments of the disclosure. Typically, higher entropy values are observed for vessel slices experiencing larger irregular deformations due to motion, whereas slices that maintain a circular and regular shape exhibit lower calculated entropy values. In FIG. 11A, triangle markers serve as a reference for comparison, demonstrating control point positions evenly distributed along the vessel, while circular markers indicate control point assignment based on the distribution of the calculated entropy values, for example, assigning more control points to vessel sections with high entropy values. The resulting control point positions are shown in FIG. 11B along the vessel.

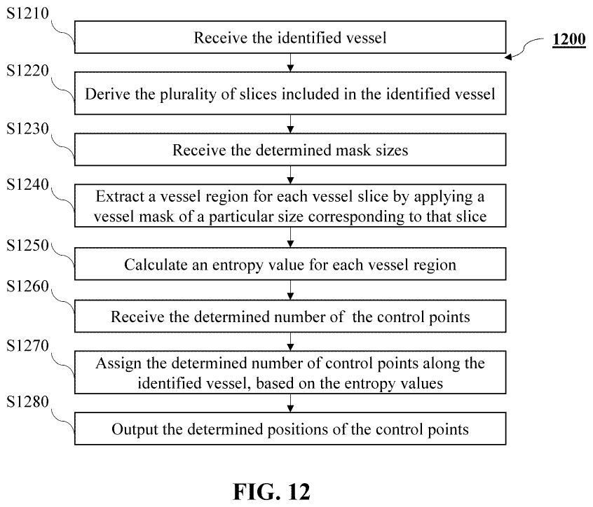

FIG. 12 shows a flow chart of an exemplary procedure 1200 for performing adaptation of the positions of the control points in accordance with embodiments of the disclosure. In step S1210, the identified vessel is received. In step S1220, the plurality of slices included in the identified vessel are derived. In step S1230, the determined mask sizes is received. In step S1240, a vessel region is extracted for each vessel slice by applying a vessel mask of a particular size corresponding to that slice. In step S1250, an entropy value is calculated for each vessel region. In step S1260, the determined number of the control points is received. In step S1270, the determined number of control points are assigned along the identified vessel, based on the calculated entropy values. In step S1280, the determined position of the control points are output.

The incorporation of the parameter adaptation described above eliminates the need for manual adjustments when dealing with various target vessels (e.g., the right coronary artery (RCA) or the left coronary artery (LCA)), patients, or varying conditions. Utilizing adaptive parameters within the optimization process not only improves the quality of motion-compensated images but also reduces the failure rate in motion correction.

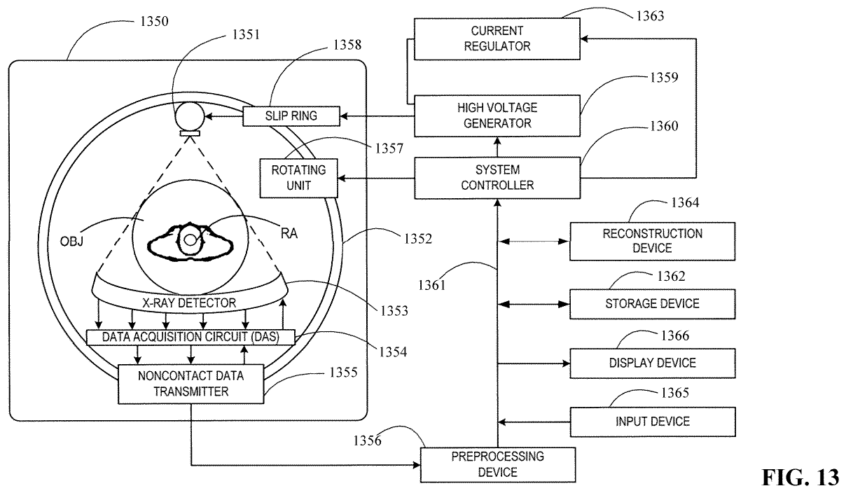

FIG. 13 is a schematic block diagram of a CT apparatus or scanner, according to one embodiment of the present disclosure. As shown in FIG. 13, a radiography gantry 1350 is illustrated from a side view and further includes an X-ray tube 1351, an annular frame 1352, and a multi-row or two-dimensional-array-type X-ray detector 1353. The X-ray tube 1351 and X-ray detector 1353 are diametrically mounted across an object OBJ on the annular frame 1352, which is rotatably supported around a rotation axis RA. A rotating unit 1357 rotates the annular frame 1352 at a high speed, such as 0.4 sec/rotation, while the object OBJ is being moved along the axis RA into or out of the illustrated page.

An embodiment of an X-ray CT apparatus according to the present disclosure will be described below with reference to the views of the accompanying drawing. Note that X-ray CT apparatuses include various types of apparatuses, e.g., a rotate/rotate-type apparatus in which an X-ray tube and X-ray detector rotate together around an object to be examined, and a stationary/rotate-type apparatus in which many detection elements are arrayed in the form of a ring or plane, and only an X-ray tube rotates around an object to be examined. The present disclosure can be applied to either type. In this case, the rotate/rotate-type, which is currently the mainstream, will be exemplified.

The multi-slice X-ray CT apparatus further includes a high voltage generator 1359 that generates a tube voltage applied to the X-ray tube 1351 through a slip ring 1358 so that the X-ray tube 1351 generates X-rays. The X-rays are emitted towards the object OBJ, whose cross-sectional area is represented by a circle. For example, the X-ray tube 1351 having an average X-ray energy during a first scan that is less than an average X-ray energy during a second scan. Thus, two or more scans can be obtained corresponding to different X-ray energies. The X-ray detector 1353 is located at the opposite side from the X-ray tube 1351 across the object OBJ for detecting the emitted X-rays that have transmitted through the object OBJ. The X-ray detector 1353 further includes individual detector elements or units.

The CT apparatus further includes other devices for processing the detected signals from the X-ray detector 1353. A data acquisition circuit or a Data Acquisition System (DAS) 1354 converts a signal output from the X-ray detector 1353 for each channel into a voltage signal, amplifies the signal, and further converts the signal into a digital signal. The X-ray detector 1353 and the DAS 1354 are configured to handle a predetermined total number of projections per rotation (TPPR).

The above-described data is sent to a preprocessing device 1356, which is housed in a console outside the radiography gantry 1350 through a non-contact data transmitter 1355. The preprocessing device 1356 performs certain corrections, such as sensitivity correction, on the raw data. A memory 1362 stores the resultant data, which is also called projection data at a stage immediately before reconstruction processing. The memory 1362 is connected to a system controller 1360 through a data/control bus 1361, together with a reconstruction device 1364, input device 1365, and display 1366. The system controller 1360 controls a current regulator 1363 that limits the current to a level sufficient for driving the CT system.

The detectors are rotated and/or fixed with respect to the patient among various generations of the CT scanner systems. In one implementation, the above-described CT system can be an example of a combined third-generation geometry and fourth-generation geometry system. In the third-generation system, the X-ray tube 1351 and the X-ray detector 1353 are diametrically mounted on the annular frame 1352 and are rotated around the object OBJ as the annular frame 1352 is rotated about the rotation axis RA. In the fourth-generation geometry system, the detectors are fixedly placed around the patient and an X-ray tube rotates around the patient. In an alternative embodiment, the radiography gantry 1350 has multiple detectors arranged on the annular frame 1352, which is supported by a C-arm and a stand.

The memory 1362 can store the measurement value representative of the irradiance of the X-rays at the X-ray detector unit 1353. Further, the memory 1362 can store a dedicated program for executing the CT image reconstruction, material decomposition, and motion estimation and motion compensation methods including the methods described herein.

The reconstruction device 1364 can execute the above-referenced methods, described herein. Further, reconstruction device 1364 can execute pre-reconstruction processing image processing such as volume rendering processing and image difference processing as needed.

The pre-reconstruction processing of the projection data performed by the preprocessing device 1356 can include correcting for detector calibrations, detector nonlinearities, and polar effects, for example.

Post-reconstruction processing performed by the reconstruction device 1364 can include filtering and smoothing the image, volume rendering processing, and image difference processing, as needed. The image reconstruction process can be performed using filtered back projection, iterative image reconstruction methods, or stochastic image reconstruction methods. The reconstruction device 1364 can use the memory to store, e.g., projection data, reconstructed images, calibration data and parameters, and computer programs.

The reconstruction device 1364 can include a CPU (processing circuitry) that can be implemented as discrete logic gates, as an Application Specific Integrated Circuit (ASIC), a Field Programmable Gate Array (FPGA) or other Complex Programmable Logic Device (CPLD). An FPGA or CPLD implementation may be coded in VDHL, Verilog, or any other hardware description language and the code may be stored in an electronic memory directly within the FPGA or CPLD, or as a separate electronic memory. Further, the memory 1362 can be non-volatile, such as ROM, EPROM, EEPROM or FLASH memory. The memory 1362 can also be volatile, such as static or dynamic RAM, and a processor, such as a microcontroller or microprocessor, can be provided to manage the electronic memory as well as the interaction between the FPGA or CPLD and the memory.

Alternatively, the CPU in the reconstruction device 1364 can execute a computer program including a set of computer-readable instructions that perform the functions described herein, the program being stored in any of the above-described non-transitory electronic memories and/or a hard disc drive, CD, DVD, FLASH drive or any other known storage media. Further, the computer-readable instructions may be provided as a utility application, background daemon, or component of an operating system, or combination thereof, executing in conjunction with a processor, such as a Xeon processor from Intel of America or an Opteron processor from AMD of America and an operating system, such as Microsoft 10, UNIX, Solaris, LINUX, Apple, MAC-OS and other operating systems known to those skilled in the art. Further, CPU can be implemented as multiple processors cooperatively working in parallel to perform the instructions.

In one implementation, the reconstructed images can be displayed on a display 1366. The display 1366 can be an LCD display, CRT display, plasma display, OLED, LED or any other display known in the art.

The memory 1362 can be a hard disk drive, CD-ROM drive, DVD drive, FLASH drive, RAM, ROM or any other electronic storage known in the art.

Numerous modifications and variations of the embodiments presented herein are possible in light of the above teachings. It is therefore to be understood that within the scope of the claims, the application may be practiced otherwise than as specifically described herein. The inventions are not limited to the examples that have just been described; it is in particular possible to combine features of the illustrated examples with one another in variants that have not been illustrated.

Embodiments of the present disclosure may also be as set forth in the following parentheticals.

(1) An apparatus for performing parameter adaptation for motion compensation in a computed tomography (CT) imaging system, the apparatus comprising processing circuitry configured to receive projection data acquired from imaging an object using the CT imaging system; reconstruct, based on the received projection data, an image of the object, without performing motion compensation; identify a vessel in the reconstructed image, the vessel including a plurality of vessel slices; determine, based on features of the identified vessel, parameters to be used during motion estimation of the identified vessel; estimate a vessel motion field using the determined parameters; and reconstruct, based on the received projection data and the estimated vessel motion field, a motion-compensated image of the object.

(2) The apparatus of (1), wherein the parameters include a size of a vessel mask to be used during the estimation of the vessel motion field, and the processing circuitry is further configured to determine the plurality of vessel slices included in the identified vessel, crop, based on a default vessel mask of a predefined default size, a vessel region around each of the plurality of vessel slices, obtain a maximum motion artifact within each of the cropped vessel regions, through a thresholding process based on a set of predefined CT value thresholds, calculate a morphological metric with respect to each vessel slice of the plurality of vessel slices, based on the obtained maximum motion artifact within the vessel region around the vessel slice, and determine a mask size for each vessel slice of the plurality of vessel slices, based on the calculated morphological metric with respect to the vessel slice.

(3) The apparatus of (2), wherein the morphological metric is represented by compactness of the obtained maximum motion artifact within the vessel region around the vessel slice, and the processing circuitry is further configured to calculate the compactness as

$$Compactness = \frac{{p}^{2}}{4 π A} ,$$

where P represents a perimeter of the obtained maximum motion artifact, and A represents an area of the obtained maximum motion artifact.

(4) The apparatus of (2), wherein the vessel mask to be used during the estimation of the vessel motion field is of a circular shape, the size of the vessel mask is characterized by a radius thereof, and the processing circuitry is further configured to determine the size of the vessel mask by using the calculated compactness as a key to obtain the radius of the vessel mask from a look-up table.

(5) The apparatus of (2), wherein the vessel mask to be used during the estimation of the vessel motion field is of a circular shape, the size of the vessel mask is characterized by a radius thereof, and the processing circuitry is further configured to determine the size of the vessel mask by applying the calculated compactness to a trained neural network to obtain the radius of the vessel mask from outputs of the neural network.

(6) The apparatus of (2), wherein the parameters further include a number of control points to be used during the estimation of the vessel motion field, and the processing circuitry is further configured to estimate a length of the identified vessel, obtain an interval between adjacent control points, and determine the number of the control points, based on the estimated length and the obtained interval.

(7) The apparatus of (6), wherein the processing circuitry is further configured to track the identified vessel to estimate a corresponding length of each vessel slice of the plurality of vessel slices included in the identified vessel, and obtain the estimated length of the identified vessel, based the estimated corresponding lengths of the plurality of vessel slices.

(8) The apparatus of (6), wherein the processing circuitry is further configured to receive an interval inputted by an operator of the CT imaging system, as the obtained interval, or derive an interval within a predefined range, as the obtained interval.

(9) The apparatus of (6), wherein the predefined range is from 15 millimeters to 20 millimeters.

(10) The apparatus of (6), wherein the parameters further include respective positions of each of the control points to be used during the estimation of the vessel motion field, and the processing circuitry is further configured to calculate a motion artifact metric with respect to each vessel slice of the plurality of vessel slices included in the identified vessel, and determine, based on the calculated motion artifact metrics, the respective positions of each of the determined number of control points.

(11) The apparatus of (10), wherein the processing circuitry is further configured to extract a vessel region around each vessel slice of the plurality of vessel slices, based on a vessel mask of a particular one of the determined mask sizes that corresponds to the vessel slice, and calculate a motion artifact level with respect to each vessel region of the extracted vessel regions, as the calculated motion artifact metrics.

(12) The apparatus of (11), wherein the processing circuitry is further configured to identify a motion artifact within each of the extracted vessel regions, and calculating entropy, compactness, or a circular score for each of the identified motion artifacts, as the calculated motion artifact levels.

(13) The apparatus of (10), wherein the processing circuitry is further configured to determine the respective positions of the determined number of control points based on a magnitude distribution of the calculated motion artifact metrics along the identified vessel.

(14) The apparatus of (13), wherein the processing circuitry is further configured to determine the respective positions of the determined number of control points by assigning more control points to a portion of the identified vessel including more vessel slices with respect to which the calculated motion artifact metrics are beyond a predefined threshold, compared with another portion of the identified vessel including fewer vessel slices with respect to which the calculated motion artifact metrics are beyond the predefined threshold.

(15) The apparatus of (13), wherein the processing circuitry is further configured not to assign a control point to a vessel slice with respect to which the calculated motion artifact metric is below a predefined threshold.

(16) A method for performing parameter adaptation for motion compensation in a computed tomography (CT) imaging system, the method comprising: receiving projection data acquired from imaging an object using the CT imaging system; reconstructing, based on the received projection data, an image of the object, without performing motion compensation; identifying a vessel in the reconstructed image, the vessel including a plurality of vessel slices; determining, based on features of the identified vessel, parameters to be used during motion estimation of the identified vessel; estimating a vessel motion field using the determined parameters; and reconstructing, based on the received projection data and the estimated vessel motion field, a motion-compensated image of the object.

(17) The method of (16), wherein the parameters include a size of a vessel mask to be used during the estimation of the vessel motion field, and the determining step further comprises: determining the plurality of vessel slices included in the identified vessel, cropping, based on a default vessel mask of a predefined default size, a vessel region around each of the plurality of vessel slices, obtaining a maximum motion artifact within each of the cropped vessel regions, through a thresholding process based on a set of predefined CT value thresholds, calculating a morphological metric with respect to each vessel slice of the plurality of vessel slices, based on the obtained maximum motion artifact within the vessel region around the vessel slice, and determining a mask size for each vessel slice of the plurality of vessel slices, based on the calculated morphological metric with respect to the vessel slice.

(18) The method of (16), wherein the parameters further include a number of control points to be used during the estimation of the vessel motion field, and the determining step further comprises: estimating a length of the identified vessel, obtaining an interval between adjacent control points, and determining the number of the control points, based on the estimated length and the obtained interval.

(19) The method of (16), wherein the parameters further include respective positions of each of the control points to be used during the estimation of the vessel motion field, and the determining step further comprises: calculating a motion artifact metric with respect to each vessel slice of the plurality of vessel slices included in the identified vessel, and determining, based on the calculated motion artifact metrics, the respective positions of each of the determined number of control points.

(20) A non-transitory computer readable medium having instructions stored therein that, when executed by one or more processors, cause the one or more processors to perform a method for performing parameter adaptation for motion compensation in a computed tomography (CT) imaging system, the method comprising: receiving projection data acquired from imaging an object using the CT imaging system; reconstructing, based on the received projection data, an image of the object, without performing motion compensation; identifying a vessel in the reconstructed image without motion compensation, the vessel including a plurality of vessel slices; determining, based on features of the identified vessel, parameters to be used during motion estimation of the identified vessel; estimating a vessel motion field using the determined parameters; and reconstructing, based on the received projection data and the estimated vessel motion field, a motion-compensated image of the object.

Numerous modifications and variations of the embodiments presented herein are possible in light of the above teachings. It is therefore to be understood that within the scope of the claims, the disclosure may be practiced otherwise than as specifically described herein.

What is claimed is:

1. An apparatus for performing parameter adaptation for motion compensation in a computed tomography (CT) imaging system, the apparatus comprising:
processing circuitry configured to
receive projection data acquired from imaging an object using the CT imaging system;
reconstruct, based on the received projection data, an image of the object, without performing motion compensation;
identify a vessel in the reconstructed image, the vessel including a plurality of vessel slices;
determine, based on features of the identified vessel, parameters to be used during motion estimation of the identified vessel;
estimate a vessel motion field using the determined parameters; and
reconstruct, based on the received projection data and the estimated vessel motion field, a motion-compensated image of the object.

2. The apparatus of claim 1, wherein the parameters include a size of a vessel mask to be used during the estimation of the vessel motion field, and the processing circuitry is further configured to:
determine the plurality of vessel slices included in the identified vessel,
crop, based on a default vessel mask of a predefined default size, a vessel region around each of the plurality of vessel slices,
obtain a maximum motion artifact within each of the cropped vessel regions, through a thresholding process based on a set of predefined CT value thresholds,
calculate a morphological metric with respect to each vessel slice of the plurality of vessel slices, based on the obtained maximum motion artifact within the vessel region around the vessel slice, and
determine a mask size for each vessel slice of the plurality of vessel slices, based on the calculated morphological metric with respect to the vessel slice.

3. The apparatus of claim 2, wherein the morphological metric is represented by compactness of the obtained maximum motion artifact within the vessel region around the vessel slice, and the processing circuitry is further configured to calculate the compactness as
$$Compactness = \frac{{p}^{2}}{4 π A} ,$$
where P represents a perimeter of the obtained maximum motion artifact, and A represents an area of the obtained maximum motion artifact.

4. The apparatus of claim 2, wherein the vessel mask to be used during the estimation of the vessel motion field is of a circular shape, the size of the vessel mask is characterized by a radius thereof, and the processing circuitry is further configured to:
determine the size of the vessel mask by using the calculated compactness as a key to obtain the radius of the vessel mask from a look-up table.

5. The apparatus of claim 2, wherein the vessel mask to be used during the estimation of the vessel motion field is of a circular shape, the size of the vessel mask is characterized by a radius thereof, and the processing circuitry is further configured to:
determine the size of the vessel mask by applying the calculated compactness to a trained neural network to obtain the radius of the vessel mask from outputs of the neural network.

6. The apparatus of claim 2, wherein the parameters further include a number of control points to be used during the estimation of the vessel motion field, and the processing circuitry is further configured to:
estimate a length of the identified vessel,
obtain an interval between adjacent control points, and
determine the number of the control points, based on the estimated length and the obtained interval.

7. The apparatus of claim 6, wherein the processing circuitry is further configured to:
track the identified vessel to estimate a corresponding length of each vessel slice of the plurality of vessel slices included in the identified vessel, and
obtain the estimated length of the identified vessel, based the estimated corresponding lengths of the plurality of vessel slices.

8. The apparatus of claim 6, wherein the processing circuitry is further configured to:
receive an interval inputted by an operator of the CT imaging system, as the obtained interval, or
derive an interval within a predefined range, as the obtained interval.

9. The apparatus of claim 6, wherein the predefined range is from 15 millimeters to 20 millimeters.

10. The apparatus of claim 6, wherein the parameters further include respective positions of each of the control points to be used during the estimation of the vessel motion field, and the processing circuitry is further configured to:
calculate a motion artifact metric with respect to each vessel slice of the plurality of vessel slices included in the identified vessel, and
determine, based on the calculated motion artifact metrics, the respective positions of each of the determined number of control points.

11. The apparatus of claim 10, wherein the processing circuitry is further configured to:
extract a vessel region around each vessel slice of the plurality of vessel slices, based on a vessel mask of a particular one of the determined mask sizes that corresponds to the vessel slice, and
calculate a motion artifact level with respect to each vessel region of the extracted vessel regions, as the calculated motion artifact metrics.

12. The apparatus of claim 11, wherein the processing circuitry is further configured to:
identify a motion artifact within each of the extracted vessel regions, and
calculating entropy, compactness, or a circular score for each of the identified motion artifacts, as the calculated motion artifact levels.

13. The apparatus of claim 10, wherein the processing circuitry is further configured to determine the respective positions of the determined number of control points based on a magnitude distribution of the calculated motion artifact metrics along the identified vessel.

14. The apparatus of claim 13, wherein the processing circuitry is further configured to determine the respective positions of the determined number of control points by assigning more control points to a portion of the identified vessel including more vessel slices with respect to which the calculated motion artifact metrics are beyond a predefined threshold, compared with another portion of the identified vessel including fewer vessel slices with respect to which the calculated motion artifact metrics are beyond the predefined threshold.

15. The apparatus of claim 13, wherein the processing circuitry is further configured not to assign a control point to a vessel slice with respect to which the calculated motion artifact metric is below a predefined threshold.

16. A method for performing parameter adaptation for motion compensation in a computed tomography (CT) imaging system, the method comprising:
receiving projection data acquired from imaging an object using the CT imaging system;
reconstructing, based on the received projection data, an image of the object, without performing motion compensation;
identifying a vessel in the reconstructed image, the vessel including a plurality of vessel slices;
determining, based on features of the identified vessel, parameters to be used during motion estimation of the identified vessel;
estimating a vessel motion field using the determined parameters; and
reconstructing, based on the received projection data and the estimated vessel motion field, a motion-compensated image of the object.

17. The method of claim 16, wherein the parameters include a size of a vessel mask to be used during the estimation of the vessel motion field, and the determining step further comprises:
determining the plurality of vessel slices included in the identified vessel,
cropping, based on a default vessel mask of a predefined default size, a vessel region around each of the plurality of vessel slices,
obtaining a maximum motion artifact within each of the cropped vessel regions, through a thresholding process based on a set of predefined CT value thresholds,
calculating a morphological metric with respect to each vessel slice of the plurality of vessel slices, based on the obtained maximum motion artifact within the vessel region around the vessel slice, and
determining a mask size for each vessel slice of the plurality of vessel slices, based on the calculated morphological metric with respect to the vessel slice.

18. The method of claim 16, wherein the parameters further include a number of control points to be used during the estimation of the vessel motion field, and the determining step further comprises:
estimating a length of the identified vessel,
obtaining an interval between adjacent control points, and
determining the number of the control points, based on the estimated length and the obtained interval.

19. The method of claim 16, wherein the parameters further include respective positions of each of the control points to be used during the estimation of the vessel motion field, and the determining step further comprises:
calculating a motion artifact metric with respect to each vessel slice of the plurality of vessel slices included in the identified vessel, and
determining, based on the calculated motion artifact metrics, the respective positions of each of the determined number of control points.

20. A non-transitory computer readable medium having instructions stored therein that, when executed by one or more processors, cause the one or more processors to perform a method for performing parameter adaptation for motion compensation in a computed tomography (CT) imaging system, the method comprising:
receiving projection data acquired from imaging an object using the CT imaging system;
reconstructing, based on the received projection data, an image of the object, without performing motion compensation;
identifying a vessel in the reconstructed image without motion compensation, the vessel including a plurality of vessel slices;
determining, based on features of the identified vessel, parameters to be used during motion estimation of the identified vessel;
estimating a vessel motion field using the determined parameters; and
reconstructing, based on the received projection data and the estimated vessel motion field, a motion-compensated image of the object.
